(19) United States
(12) Patent Application Publication
(10) Pub. No.: US 2009/0083090 A1
(43) Pub. Date: Mar. 26, 2009

(54) COMPREHENSIVE WASTE BILLING SYSTEM

(75) Inventors: Timothy J. Rolfes, Loveland, OH (US); Jeffery D. Crawford, Cincinnati, OH (US); Todd A. Kinross, Maineville, OH (US); Geoffrey D. Mayernik, Cincinnati, OH (US); Joseph M. Mayernik, Cincinnati, OH (US)

Correspondence Address: WOOD, HERRON & EVANS, LLP, 2700 CAREW TOWER, 441 VINE STREET, CINCINNATI, OH, 45202, US

(73) Assignee: HEALTHCARE WASTE SOLUTIONS, LLC, Cincinnati, OH (US)

(21) Appl. No.: 11/859,486

(22) Filed: Sep. 21, 2007

(51) Int. Cl. G06Q 30/00; G06Q 20/00

(52) U.S. Cl. 705/7; 705/1; 705/40; 705/400

(57) ABSTRACT

An apparatus, program product and method validate service provider invoices for a customer to ensure that the waste disposal services associated with such invoices are both authorized to be performed and priced correctly in view of a contract between the customer and the service provider. Such invoice validation may be performed in connection with aggregating invoices from multiple service providers, paying those service providers, and generating on behalf of a customer a composite invoice that itemizes the waste disposal costs and services from multiple service providers. In addition, in some implementations a third party that assesses a customer's waste disposal services is permitted to share in the savings of a customer resulting from the assessment. A third party and a customer agree upon a cost reduction that the third party promises to realize for the customer, and to the extent the realized cost reduction for the customer exceeds the agreed-upon amount, at least a portion of the realized cost reduction that exceeds the agreed-upon amount is awarded to the third party.

### FIELD OF THE INVENTION

The present invention generally relates to waste disposal services in healthcare and other industries, and in particular, to billing and auditing services associated with waste disposal.

### BACKGROUND OF THE INVENTION

Healthcare facilities around the world allocate significant resources to managing waste. Hospital waste is unique in several ways. For instance, there is a large variety of different types of waste, or waste streams, having very different handling and other disposal requirements. Healthcare waste streams are generally categorized to include solid, regulated medical and recycling waste. Other waste streams include confidential documents, hazardous and construction debris waste.

For instance, hospitals employ toxic chemicals and hazardous materials for numerous diagnostic and treatment purposes. Examples of hazardous materials include formaldehyde, photographic chemicals, radio nuclides, solvents, mercury, waste, anesthetic gases and other toxic, corrosive chemicals.

Regulated medical waste generally includes materials generated in the diagnosis, treatment, research, or immunization of human beings or animals. Examples of regulated medical waste includes: cultures and stocks, pathological wastes, human blood and blood products, sharps, certain animal waste and isolation wastes. Other types of solid (unregulated and nonhazardous) waste is referred to within the industry as the solid waste stream.

Confidential material produced by healthcare facilities comes in many forms. From patient records to billing reports to pharmacy bottles, wristbands, and a variety of other printed materials, private patient information abounds within the healthcare system. Controlling and limiting the hospital's risk in unintentional disclosure of this information is challenging.

Hospitals and other healthcare service providers additionally must manage tons of solid and recycling waste, in addition to periodic construction debris attributable to expansion or remodeling.

Despite the significant dollars spent on managing waste, few healthcare systems have historically focused on maximizing the value received in this area. One area of particular concern relates to managing the delivery and payment of waste disposal services. A typical multi-facility healthcare system will contract with several waste disposal service providers to handle the multitude of waste streams generated by the various facilities in the system, and may receive hundreds of paper invoices per month from these providers based upon the different waste streams and facilities for which waste disposal services have been provided. Often, due to the fact that each waste stream's economic structure is typically unique to that particular waste stream, the manner in which charges are incurred and services are invoiced will vary from stream to stream, and from facility to facility. For instance, solid waste invoices are often based on per ton pricing, while regular medical waste invoices are often based on per pound or per container. Invoices may also be broken down based upon container size and frequency of pick-up.

As a result, many healthcare systems are relegated to working with dozens of service providers and having to process thousands of different paper invoices. In addition, due to the sheer volume and complexity of the paperwork, it is often difficult to ensure that waste disposal services are being rendered in an efficient and cost effective manner. Billed rates may in some instances be inconsistent with the contracted rates, and invoices may include unexpected charges and fees.

Furthermore, waste disposal services rendered at particular service locations may be inadequate or excessive, leading to either poor service or excessive charges. As an example, a facility might have a three yard dumpster that is being emptied twice a week, but that is routinely only half full when it is emptied. By replacing the dumpster with a smaller dumpster, or reducing the pickup schedule to once a week, the same amount of waste could be handled for a much more cost effective price.

Conventional accounting practices provide little incentive for service providers to be more efficient, and provide limited information and options that could lead to improvement. Healthcare systems, on the other hand, typically lack the expertise and/or manpower to continually monitor their waste disposal services for accuracy or to identify potential areas for savings.

There consequently exists a need for managing the delivery and payment of waste delivery services in healthcare and other facilities.

### SUMMARY OF THE INVENTION

The invention addresses these and other problems associated with the prior art by providing an apparatus, program product and method that validate service provider invoices for a customer to ensure that the waste disposal services associated with such invoices are both authorized to be performed and priced correctly in view of a contract between the customer and the service provider. In addition, in some embodiments of the invention, such invoice validation may be performed in connection with aggregating invoices from multiple service providers, paying those service providers, and generating on behalf of a customer a composite invoice that itemizes the waste disposal costs and services from multiple service providers. The composite invoice to the customer may also be electronic in format, offering additional efficiencies for the customer when the electronic invoice is received and processed at the customer's location.

Consistent with one aspect of the invention, therefore, a service provider invoice associated with delivery of waste disposal service is processed by receiving invoice data associated with a service provider invoice, the invoice data identifying at least one waste disposal service provided at a service location for a customer and a cost for the waste disposal service; accessing service location data for the customer to validate the waste disposal service provided by the service provider at the service location; and accessing contract data associated with a contract between the service provider and the customer to validate the cost for the waste disposal service.

The invention also addresses other problems associated with the prior art by providing a method, apparatus and program product that enable a third party to calculate, report and share in the savings of a customer resulting from assessing the provision of waste disposal services for a customer. A third party and a customer agree upon a cost reduction that the third party promises to realize for the customer, and to the extent the realized cost reduction for the customer exceeds the agreed-upon amount, at least a portion of the realized cost reduction that exceeds the agreed-upon amount is awarded to the third party. As a result, both the customer and third party benefit from the assessment of the customer's waste disposal services, and both are economically motivated to ensure that the provision of the customer's waste disposal services is efficient as possible.

Consistent with this aspect of the invention, therefore, a customer is billed for savings associated with waste disposal services provided by a plurality of waste service providers by determining a baseline cost associated with the provision of waste disposal services for the customer by the plurality of waste service providers; with a third party, assessing the provision of waste disposal services for the customer to identify at least one cost saving opportunity for the customer; determining a realized cost reduction resulting from implementation of the cost saving opportunity; and determining an amount due from the customer to the third party resulting from the realized cost reduction exceeding an agreed-upon cost reduction promised to the customer by the third party.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a comprehensive waste billing system consistent with the invention.

FIG. 2 is a block diagram illustrating the process flow of invoices in the system of FIG. 1.

FIG. 3 is a block diagram of the mapping matrix referenced in FIG. 2.

FIG. 4 is a flowchart illustrating an exemplary customer initialization process used in the system of FIG. 1.

FIG. 5 is a flowchart illustrating an exemplary implementation of the contract setup process referenced in FIG. 4.

FIG. 6 is a flowchart illustrating an exemplary implementation of the invoice validation process referenced in FIG. 4.

FIG. 7 is a flowchart illustrating an exemplary implementation of the contract validation process referenced in FIG. 4.

FIG. 8 is a flowchart illustrating an exemplary implementation of the savings calculation process referenced in FIG. 4.

FIG. 9 is a flowchart illustrating an exemplary implementation of the reporting process referenced in FIG. 4.

FIG. 10 is a flowchart illustrating an exemplary implementation of the tolerance calculation process referenced in FIG. 4.

FIG. 11 is a portion of an exemplary tolerance report generated by the tolerance calculation process of FIG. 10.

FIG. 12 is a flowchart illustrating an exemplary assessment and validation process incorporating cost reduction sharing consistent with the invention.

FIG. 13 is a block diagram of an exemplary computer display of discrepancies identified in a validation process consistent with the invention.

### DETAILED DESCRIPTION

The embodiments described hereinafter provide comprehensive waste billing assessment for waste disposal services supplied to healthcare and other facilities. Among other features, embodiments consistent with the invention enable a customer's invoices from multiple service providers, servicing multiple waste streams, to be collected and validated against the contracts between the customer and the service providers, identify and potentially correct any inconsistencies therein, and render payment for validated invoices. Furthermore, embodiments consistent with the invention may also consolidate and aggregate multiple invoices into a single composite invoice for a customer, broken down in a format that enables customer management to better understand the customer's overall waste management situation.

In addition, embodiments consistent with the invention enable a comprehensive waste billing operator to offer a customer a unique billing arrangement whereby the operator and the customer agree to share in the proceeds of a customer's savings. In particular, a customer may contract with a comprehensive waste billing operator to provide the herein-described services, and as a component of such an arrangement, may agree to pay the operator a percentage of the savings obtained by the operator as compared to prior to the initiation of comprehensive waste billing consistent with the invention. Thus, for example, a customer and operator may agree that, as per the contract terms, the operator will reduce the customer's waste disposal costs by 25% per annum, and that, for any savings realized beyond the 25% amount, the operator will be entitled to 50% of the savings. As such, the operator may bill the customer an additional amount of 50% of any calculated savings above and beyond the 25% saved by the operator.

A customer, within the context of the invention, is typically a receiver of waste disposal services, and more typically a receiver of waste disposal services for multiple waste streams and from multiple service providers. A service provider represents a provider of waste disposal services, and may represent a provider of multiple types of services and/or for multiple waste streams. In addition, a single legal entity may constitute several service providers in some instances. A comprehensive waste billing system operator is typically a third party that has contracted with a customer to handle the payment of service provider invoices on behalf of a customer. It will be appreciated in some embodiments, however, that a comprehensive waste billing system operator may only provide auditing or analysis services, and may not handle the direct payment of invoices. In still other embodiments, the operator may not be a third party, and may be affiliated with a customer, from the standpoint of internally analyzing and validating invoices on behalf of a customer.

The embodiments hereinafter focus on implementation of the above-identified services within the healthcare industry. As such, the types of waste streams that may be handled include waste streams such as solid waste, hazardous waste, regulated medical waste, confidential documents, recycled waste, electronic waste, etc. It will be appreciated, however, that the principles of the invention may be utilized in connection with managing the payment of invoices for waste disposal services utilized by different industries whereby the disposal of multiple types of waste streams is required, and where the types of waste streams may vary. Some aspects of the invention may also be suitable for use in connection with industries other than waste disposal. The invention is therefore not limited to the particular embodiments discussed herein.

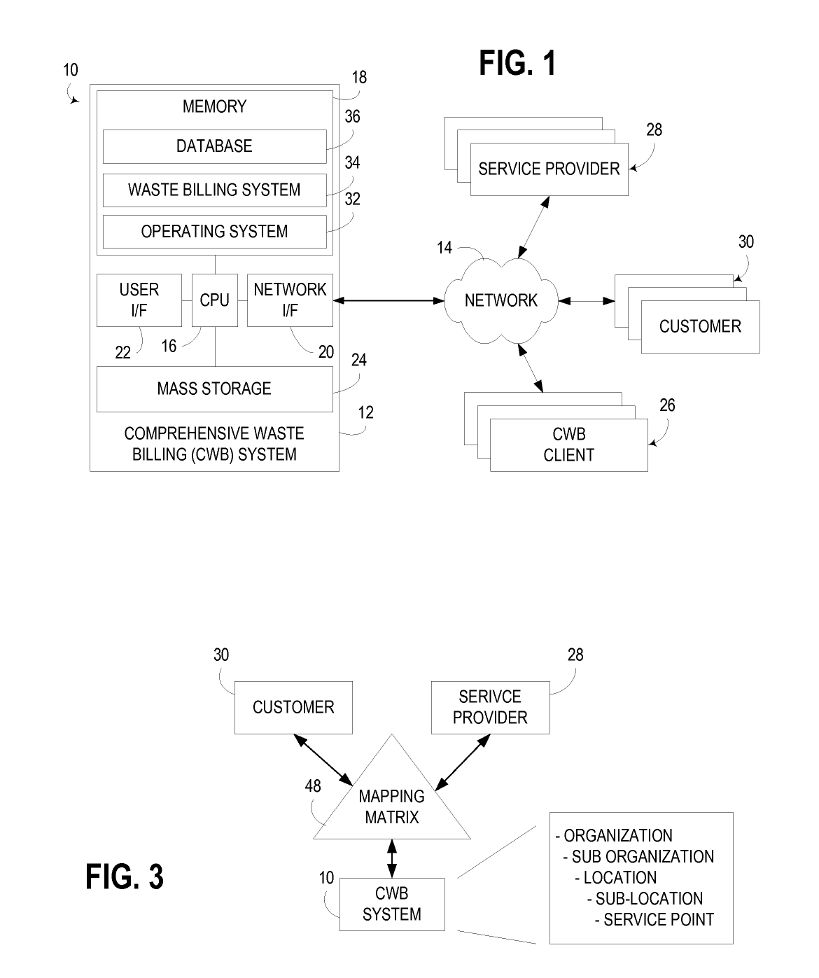

Turning now to the Drawings, wherein like numbers denote like parts throughout the several views, FIG. 1 illustrates an exemplary comprehensive waste billing (CWB) system 10 consistent with the invention. System 10 includes one or more computers 12, each of which generically represents, for example, any of a number of multi-user computers such as a network server, a midrange computer, a mainframe computer, etc. However, it should be appreciated that the invention may be implemented in other computers and data processing systems, e.g., in single-user computers such as workstations, desktop computers, portable computers, and the like, or in other programmable electronic devices (e.g., incorporating embedded controllers and the like).

Each computer 12 is coupled to a network 14, which may be implemented using any combination of LAN's, WAN's, and the Internet. Each computer generally includes a central processing unit (CPU) 16 including one or more system processors and coupled to a memory or main storage 18, typically through one or more levels of cache memory (not shown). Furthermore, CPU 16 may be coupled to additional peripheral components, e.g., one or more networks 14 via a network interface 20, various input/output devices (e.g., a control panel, display, keyboard, mouse and/or dedicated workstation, etc.) via a user interface 22, and mass storage 24 (e.g., a DASD or one or more disk drives). Any number of alternate computer architectures may be used in the alternative.

Also illustrated as coupled to network 14 are a plurality of CWB client computers 26, which may be connected to computers 12 via private and/or public networks such as the Internet to access system 10 in order to enter contract, provider and customer data into system 10, perform billing assessments and otherwise manage the operation of system 10. In addition, system 10 may be linked over network 14 to one or more service providers 28 and one or more customers 30, e.g., to receive electronic invoices from service providers, to render payment to service providers, and to send reports and invoices to customers.

Each computer 12 is further configured to host a number of levels of software suitable for implementing comprehensive waste billing consistent with the invention. Shown resident in memory 18 is operating system program code 32, as well as waste billing system program code 34 and a database 36 within which service provider and customer data is maintained.

The discussion hereinafter will focus on the specific routines utilized to implement the above-described comprehensive waste billing system. The routines executed to implement the embodiments of the invention, whether implemented as part of an operating system or a specific application, component, program, object, module or sequence of instructions, will also be referred to herein as “computer program code,” or simply “program code.” The computer program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable signal bearing media used to actually carry out the distribution. Examples of computer readable signal bearing media include but are not limited to physical, recordable type media such as volatile and nonvolatile memory devices, floppy and other removable disks, hard disk drives, optical disks (e.g., CD-ROM's, DVD's, etc.), among others, and transmission type media such as digital and analog communication links.

In addition, various program code described hereinafter may be identified based upon the application or software component within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

Those skilled in the art will recognize that the exemplary environment illustrated in FIG. 1 is not intended to limit the present invention. Those skilled in the art will recognize that other alternative hardware and/or software environments may be used without departing from the scope of the invention.

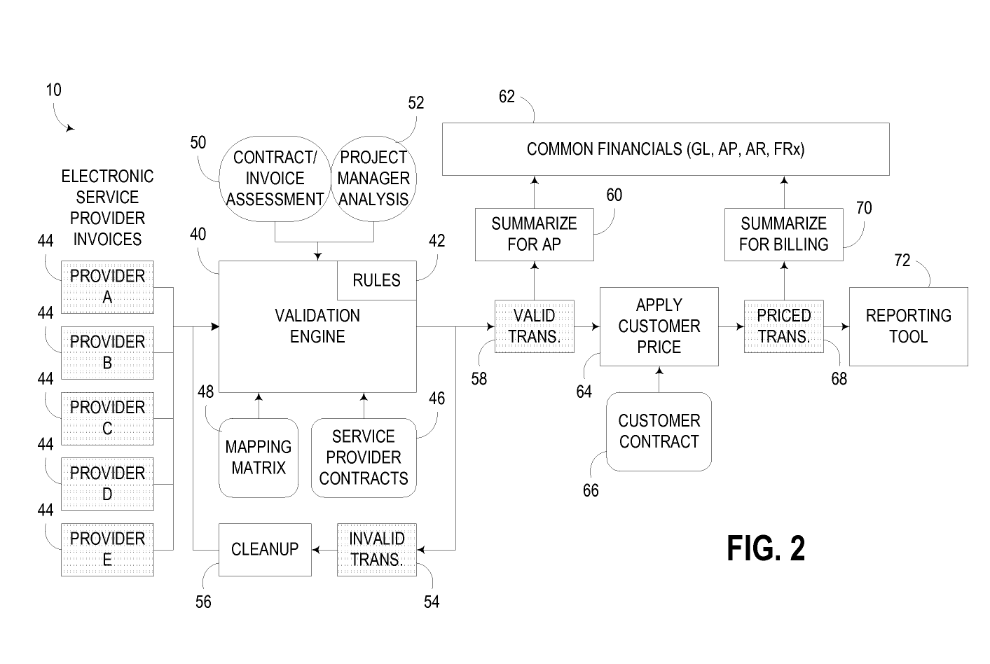

FIG. 2 illustrates the overall process flow utilized in system 10 for the purpose of processing invoices for multiple waste streams received from multiple service providers. Among other functions, system 1 0 assists in collecting invoices for a customer from waste disposal service providers, validates and analyzes the invoices against the contract terms between the customer and those providers, accumulates data for accounts payable to render payment for the invoices, optionally applies customer pricing as per any agreement between the customer and the operator of system 10, accumulates data for customer invoicing, generates electronic records for customer invoicing, and generates reports related to various aspects of the customer's waste disposal services.

System 10 relies on a rules-based validation engine 40 that applies a set of rules 42 to service provider invoices, such as electronic service provider invoices 44, in order to validate the invoices against one or more service provider contracts 46 to identify any inconsistencies between the services actually provided and billed by a service provider and the services agreed to be performed pursuant to that service provider's contract(s). Among the types of inconsistencies that may be identified include incorrect rates or amounts, services rendered for service points that do not exist, unauthorized services (e.g., too frequent pickups), services that do not match the service point capabilities (e.g., waste volumes that could realistically have been disposed in a particular container), waste streams not authorized to be serviced, etc.

The validation performed by validation engine 40 principally focuses on two types of validations. First, invoice validation processes service data in invoice data associated with a service provider invoice and attempts to ascertain whether any waste disposal service identified in the invoice data as being provided at a service location for a customer is accurate, e.g., by determining whether the service location actually exists, whether the waste stream is present at that location, whether the service provider has contracted or is otherwise authorized to perform the service at that location, whether a specified service item (e.g., container) is actually present at a location, etc. Also, format and data validation may also be performed on the invoice data.

Second, invoice validation processes cost data in invoice data associated with a service provider invoice and attempts to ascertain whether the cost associated with a waste disposal service identified in the invoice data is consistent with contract data for a contract between the service provider and the customer, principally to determine if a customer was incorrectly overcharged for the services rendered. The cost validation may incorporate accessing rate data associated with the service location in the contract and determining whether the cost is accurate, or at least within a specified tolerance, based upon the rate data.

Validation engine 40 also relies on a mapping matrix 48. As shown in FIG. 3, for example, mapping matrix 48 maps the respective identifications for service points, or individual service locations, between service provider 28, customer 30 and system 10. For example, a service provider might identify a particular dumpster located at a receiving dock with a numerical identifier such as “70-215002”, while a customer might identify that same dumpster as “East Dock Dumpster” with Org 25, Area 2007, GL 1473 charge codes. System 10 may identify the dumpster by a more formalized structure, e.g., based upon organization, sub-organization (if necessary), location and sub-location (if necessary), and individual service point. Location, for example, might represent a particular multi-building facility, whereby a sub-location might represent a particular building at the facility.

Mapping matrix 48 may also be used to map additional data relied upon by customers and service providers, e.g., billing or charge codes, service types, account numbers, etc. In one embodiment, for example, it is desirable to map both a customer's identification, and the customer's charge code, for a service point with a service provider's identification to facilitate a customer's accounting of service provider charges to the customer's internal accounts.

Mapping matrix 48 therefore enables the CWB system to map the identifiers used by service providers with the identifiers used by customers, such that invoices that reference particular service points can be validated against customer identifiers, and such that customers can have billing information for particular service points provided in a format that is compatible with the customers' systems. As a result, all waste stream activity can be matched and reported in formats that service providers, CWB system operators and customers can easily understand. Among other benefits, this enables a flexible, changeable, multi-level customer driven reporting hierarchy to be implemented so that activity can be reported to customers in whatever format is most desirable for the customer.

Returning to FIG. 2, validation engine 40 supports a number of operations that may be requested by a CWB system operator. For example, validation engine 40 may be used to perform contract and/or invoice assessment as shown at block 50. In addition, validation engine 40 may be used to perform more detailed analysis, such as may be performed by a project manager in connection with assessing a customer's overall waste management processes, as shown at block 52. Assessment of a customer's waste management processes may utilize a number of techniques, e.g., as described in U.S. Provisional Patent Application Ser. No. 60/759,363, filed on Jan. 17, 2006 by Geoffrey Mayernik and entitled “HEALTHCARE WASTE ASSESSMENT TOOL,” and U.S. patent application Ser. No. 11/624,022, filed on Jan. 17, 2007 by Geoffrey Mayernik and entitled “COMPREHENSIVE HEALTHCARE WASTE ASSESSMENT SYSTEM,” the disclosures of which are incorporated by reference herein.

To process an invoice, validation engine 40 receives an electronic invoice 44 from a service provider, e.g., via email or an electronic invoicing system, constituting a transaction for CWB system 10. In the vent a service provider cannot provide an electronic transaction, system 10 allows for paper invoices to be entered in an electronic format, e.g., via manual entry, scanning, and/or OCR, among others. In the alternative, invoices may be in paper format and scanned or manually entered by a CWB system operator. Validation engine 40 applies one or more rules 42 to the invoice to compare the invoice terms against the contract 46 for the service provider associated with the invoice, with mapping matrix 48 used to map service location identified by the service provider in the invoice with the customer's and operator's service location identifiers.

The validation engine, upon processing an invoice, determines that the invoice is valid or invalid. If invalid, e.g., due to a discrepancy such as an unauthorized service or an incorrect rate, the invalid transaction 54 is passed to a cleanup block 56, which may be automated or manually implemented, to fix the transaction. For example, the service provider may be contacted to revise and resubmit the invoice, or the invoice may be edited by the CWB system operator into a proper format. The revised invoice is then typically returned to the validation engine for reprocessing.

If the invoice is valid, the valid transaction 58 is then summarized in block 60 for accounts payable (AP), and forwarded to a common financial application, e.g., a general ledger or accounts receivable application, such that the invoice can be paid. In addition, the valid transaction 58 is passed to block 64 to apply customer pricing to the transaction for the purposes of invoicing the customer for the invoice. In this regard, the contract 66 between the CWB system operator and the customer is accessed to determine what, if any adjustments need to be made to the invoice prior to invoicing the customer. For example, if the calculated savings on the customer invoice exceed an agreed-upon amount, the customer may be billed a surcharge representing a percentage of the savings that were realized above the agreed-upon amount. Other adjustments, such as charges for performing comprehensive waste billing, adding a standard mark up percentage, etc., may also be performed.

The output of block 64 is a priced transaction, which represents the adjusted invoice. This transaction is forwarded to a common financial application 62, e.g., an accounts receivable application, in order to invoice the customer. In addition, the priced transaction may also be forwarded to a reporting tool 72 to enable various reporting and analysis operations to be performed. These reports may be used to provide supporting details for the invoice amount.

It will be appreciated that invoices may be processed individually, or may be collected and processed together in different embodiments. For example, it is typically desirable to compile priced transactions from multiple service provider invoices and provide a single, composite invoice to the customer. It may also be desirable to compile multiple invoices from the same service provider and process such invoices in a single batch. In addition, through the use of the mapping matrix, customer invoices may be generated with line items that identify appropriate charge codes for the customer. Customer charge codes may be tied to specific service locations, organizations, sub-organizations, locations, sub-locations, or any combination thereof, such that any charges presented by a service provider can be mapped to the appropriate charge codes for the customer. As a result, customer personnel receiving the composite invoice can readily ascertain the origins of the charges and allocate those charges to the appropriate accounts and/or business units. In the alternative, if the composite invoice is in an electronic format, the invoice can be directly imported into the customer's financial system, saving significant time and effort for the customer.

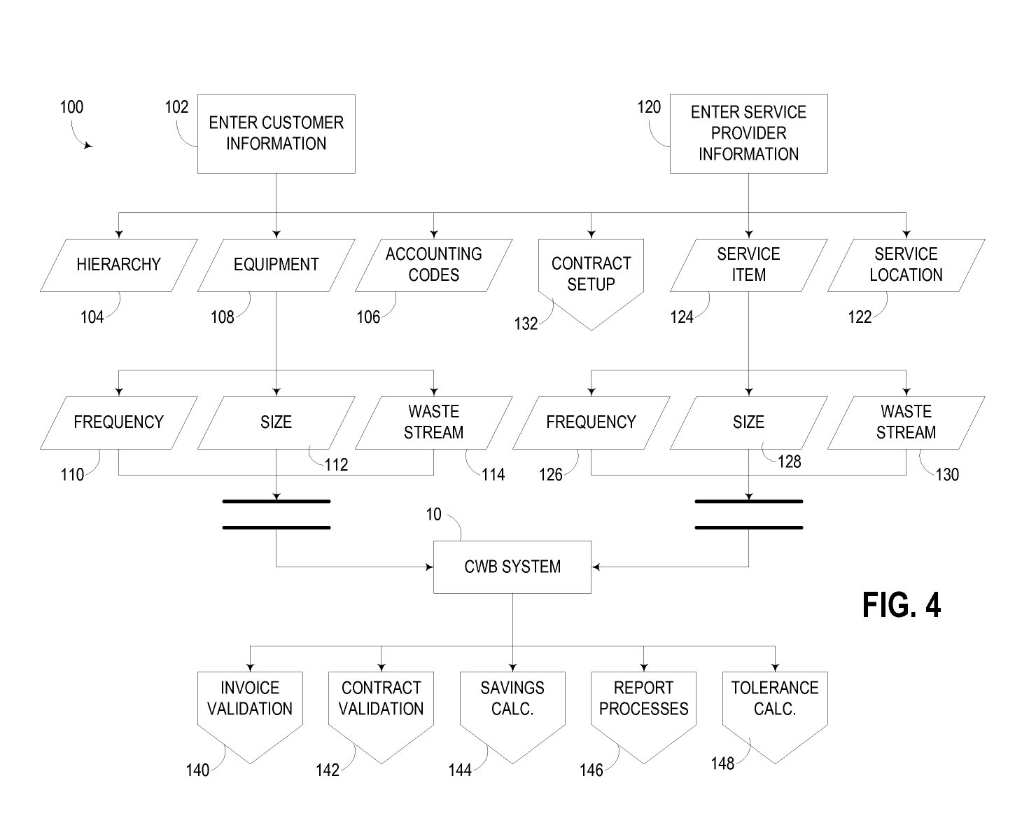

Now turning to FIG. 4, an exemplary customer initialization process 100 is described in further detail. Process 100 illustrates the input of customer, service provider, and contract information into CWB system 10. For a customer, customer information is input by an operator at block 102, including, among other relevant information, hierarchy information 104, related to the organizational hierarchy of the customer, including the hierarchy of service points. Also input is customer accounting codes 106, related to the accounts to which customer invoice items should be billed.

The input customer information also includes equipment information 108, representative of the location and other particulars for each service point for the customer. As noted above, a service point may represent any location whereby a waste disposal service is provided. The granularity of a service point may vary in different embodiments, and may be broken down, for example, into a single container, e.g., a garbage can, a sharps container, a dumpster, etc., and may identify the organization, sub-organization, location and sub-location of the item. For each equipment item 108, characteristic information about the item may be entered, e.g., the frequency of pickup 110, the size of the item 112. and the waste stream 114 with which the equipment is associated.

Likewise, for each service provider, service provider information is input as shown at block 120, including an input of the service locations 122 recognized by the service provider, and a list of service items 124 located at the service locations. For each service item 124, information such as frequency of pickup 126, size 128 and waste stream 130 is also input.

It will be appreciated that additional information may be entered for each customer and/or service provider, including, for example, address and account information, as well as supplemental information regarding routing of invoices and payments, contact information, formatting information for general ledger inputs, etc. In addition, it will be appreciated that information associated with a service provider or customer can be reused for different records, e.g., if the same service provider services multiple customers, or uses a set of known containers with known information (e.g., 3 yard dumpsters), in order to facilitate data entry into CWB system 10.

Data input in blocks 102 and 120 is provided to CWB system 10 and stored in the database thereof. In addition, contracts between the operator and customer, and between the customer and each service provider, are input using a contract setup routine 132, discussed in greater detail below. Once entered, the information may be used to perform several steps associated with analyzing and validating customer invoices, including invoice validation 140, contract validation 142, savings calculation 144, process reporting 146 and tolerance calculation 148. These processes are also described in greater detail below.

In one embodiment consistent with the invention, for example, each customer location may be identified by organization, sub-organization, name, address, city, state and ZIP code. The ability to provide notes may also be supported. For each customer service point, the service point may be associated with an organization, sub-organization, location and sub-location, and may be associated with a particular address, city, state, ZIP code, and name, and may be additionally associated with an abbreviation, a start date and a stop date.

In addition, for each service item identified for a service provider, that service item may be associated with a waste stream and service provider identifier. In addition, the operator can map the service item to an existing service point for a customer. This mapping is then stored in the mapping matrix such that the service point is associated with the customer and service provider. An additional CWB system identifier may also be input if desired.

In one exemplary embodiment, for instance, a CWB system operator, such as a project manager, may perform a customer audit upon processing of a new customer. In doing so, a customer's information would be set up by first entering the service provider information and authorizations for the customer, and optionally, entering any name and address information if not already entered. Then, customer defined codes and combinations may be created to differentiate between a customer's unique items (waste streams, frequencies, service containers, etc), and the authorized waste streams and waste containers may be entered for the customer. Service provider account numbers may also be mapped to specific service containers/locations to the location specified for a customer, and frequencies for pickup of specific service containers at specific locations may be defined.

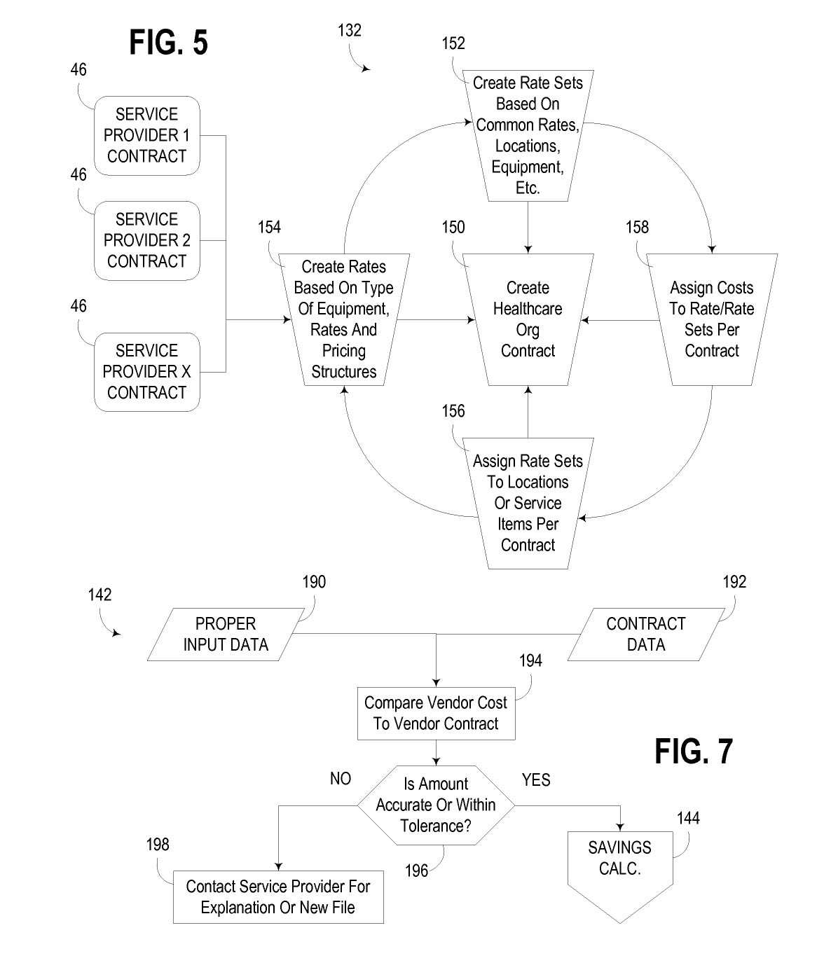

FIG. 5 next illustrates the contract setup process 132 in greater detail, in particular for inputting a service provider contract for a customer and generating an overall contract for the customer (“healthcare org contract”). Data from a service provider contract 46 is used to build an overall healthcare organization contract as shown at block 150, by inputting several types of information represented in blocks 152-158. In particular, as shown in block 152, rate sets are created based upon common rates, locations, equipment, etc. These rate sets may be created prior to processing any particular contract for a customer, as the rate sets are based upon industry or market standards. In addition, rates are created in block 154 based upon the type of equipment specified in a contract, as well as the rates and pricing structures specified in the contract. Rates can include, for example, calculations from line items, contracts, manifests, locations or constants.

In addition, as shown in block 156, rate sets may be assigned to locations or service items as per a contract. In addition, different rate sets and costs can be included based on date ranges, with the most recent rate sets taking precedence. Furthermore, as shown in block 158, costs may be assigned to rates or rate sets as per a contract, with rate sets assigned to any position in a hierarchy for an organization. In addition, rates and/or rate sets may be inheritable, e.g., by assigning rates or rate sets to an organization or sub-organization, and defaulting any service points within a particular organization or sub-organization to those rates or rate sets unless overridden for a particular service location.

From the aforementioned information, the contract is specified and added to an overall healthcare organization contract as shown at block 150.

A rate, for example, may be associated with a particular name and abbreviation, and may be activated or deactivated for a particular service point. For example, one exemplary rate might be “NONHAZ PHARM PP”, described as Non-Hazardous Pharma Waste Per Pound. It may be desirable to permit an operator to input, for that rate, a description, a contract type, and one or more rate parameters, constituting one or more rate calculations. A rate calculation, for example, may require entry of a calculation type, notes, one or more variables (e.g., invoice variables, line item variables, manifest variables, batch variables, month variables, savings variables, and may be based upon calculation types such as “add,” “divide,” “has no duplicates,” “is equal to,” “is greater than,” etc., which may be combined using one or more variables and constants to effectively generate a “rule” for the contract. A simple rate might be “$3.00 per pound,” where the rate is $3.00 and the rate calculation is “rate*weight”. A more complex rule for a particular service location might be, for example:

IF (numContainers>2) rate=(numContainers−2)* rate)+stopFee

Any number of fields can be specified for a particular rate or rate set, e.g., quantity, weight, constants, contract costs, calculated costs, billed costs, cumulated numbers of calculations, etc.

In the aforementioned exemplary embodiment, setup of a customer's contract may incorporate defining rates and rate calculations (e.g., weight * disposal rate=disposal cost), as well as defining rate sets, e.g., different rates for different geographic zones, or for Large Quantity Generators vs. Small Quantity Generators). Rates may be assigned to rate sets, and service provider contracts created by assigning service providers and rate sets to a service provider's hierarchy nodes, and assigning actual costs to specific items as required. A customer's contract may then be created by assigning authorized service providers, assigning rate sets, assigning rate sets to a customer's hierarchy nodes, and assigning actual costs to specific items.

It will be appreciated that a wide variety of rates, calculations, exceptions, and rules may be implemented to cover practically any billing scenario for a service provider. Implementation of such rules would be well within the abilities of one of ordinary skill in the art having the benefit of the instant disclosure.

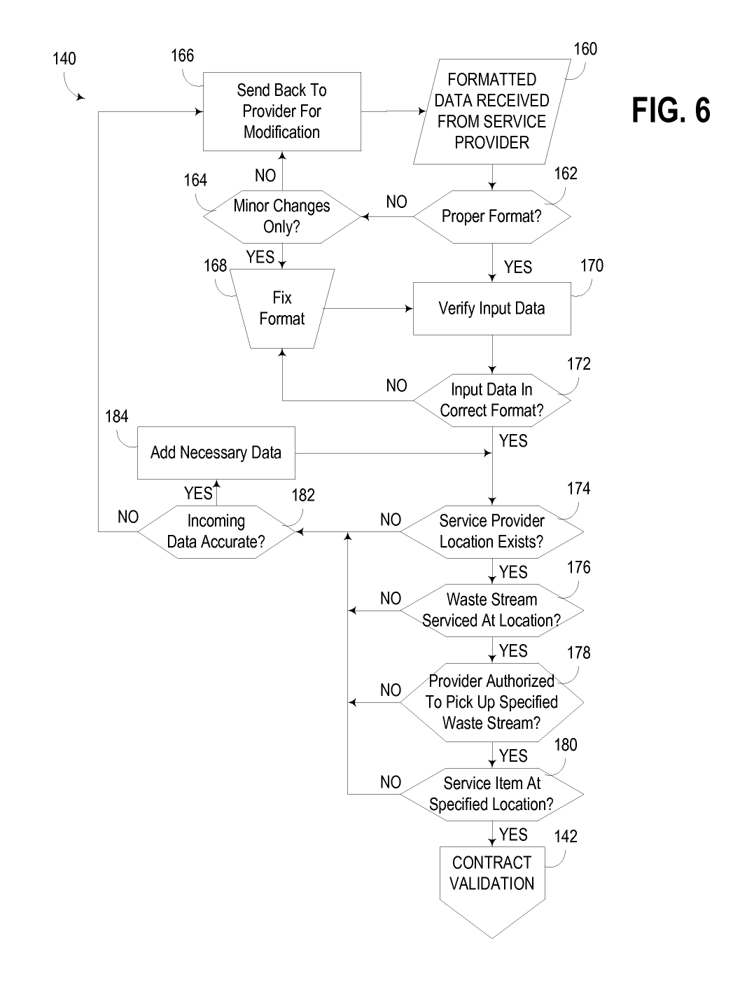

Now turning to FIG. 6, an exemplary implementation of an invoice validation process 140 is illustrated in greater detail. In particular, upon receiving formatted data from a service provider 160, the formatted data is analyzed in block 162 to determine if the data is in a proper format. For example, block 162 may determine there are too many or not enough columns, or any incorrectly-named tabs or columns.

If the data is not in a proper format, control passes to block 164 to determine if only minor changes are required. If more than minor changes are required, control passes to block 166 send the data back to the service provider for modification, whereby process 140 awaits the receipt of new data as shown at block 160.

If minor changes are required, block 164 passes control to block 168 to fix the data format, e.g., by prompting an operator to fix the data. Once the data is fixed in block 168, or if the data is determined to be of proper format in block 162, block 170 is next executed to verify the input data, e.g., to determine if the data is of a proper type (e.g., text or numeric), to determine if mandatory fields are present (e.g., totals). Block 172 then determines if the input data is in the correct format. If not, control passes to block 168 to prompt the operator to fix the format.

If the data is in the correct format, control passes to block 174 to process the service location data in the invoice. Specifically, block 174 determines whether the location specified in the invoice actually exists, e.g., by accessing the mapping matrix to determine whether a customer location exists for the specified service provider location. Block 176 then determines whether the waste stream specified in the invoice is serviced at the specified location, block 178 determines whether the service provider is authorized to pick up the specified waste stream at the specified location, and block 180 determines if the service item specified in the invoice (i.e., a container, dumpster, etc.) is present at the specified location. If each of the conditions in blocks 174-180 is met, the invoice is validated for that service location, and control can pass to the contract validation process 142. However, if any of the conditions is not met, control passes from the respective block to block 182 to determine whether the incoming data is accurate, e.g., by manual verification. If not, control passes to block 166 to send the data back to the provider for modification. Otherwise, control passes to block 184 to add any necessary data, and control returns to block 174 to reprocess the service location data in the invoice. In the event any discrepancies are encountered in blocks 174-180, a report or log is generated to show the outstanding discrepancies, which can then be manually reviewed and corrected prior to reprocessing.

It will be appreciated that process 140 as illustrated processes invoices that reference single service locations. In other implementations, an invoice may reference multiple service locations, and as such, a process similar to process 140 may be used to iterate through the data for each service location referenced in an invoice.

Now turning to FIG. 7, an exemplary implementation of contract validation process 142 is illustrated in greater detail. Process 142 retrieves the now-validated invoice data (referenced at block 190) and the contract data for the service provider (referenced at block 192) contract and compares the invoice cost data with the contract in block 194. As noted above, the charges may be based upon rates and rate sets established for the contract, and the charges may have multiple line items, e.g., based upon surcharges or other services that may be rendered by a service provider.

Based upon the comparison in block 194, block 196 determines whether the charges are accurate, or within a tolerance established for the contract (discussed in greater detail below). The contract amount, in this determination, may be determined by location, frequency, container type, waste stream, minimum charges specified in the initial contract terms, etc. If the charges are accurate, control passes to the savings calculation process 144. Otherwise, if a discrepancy is noted, control passes to block 198 to contact the service provider for an explanation, or to request a new invoice file. In addition, a discrepancy is logged in the system for later viewing of the error by an operator if desired.

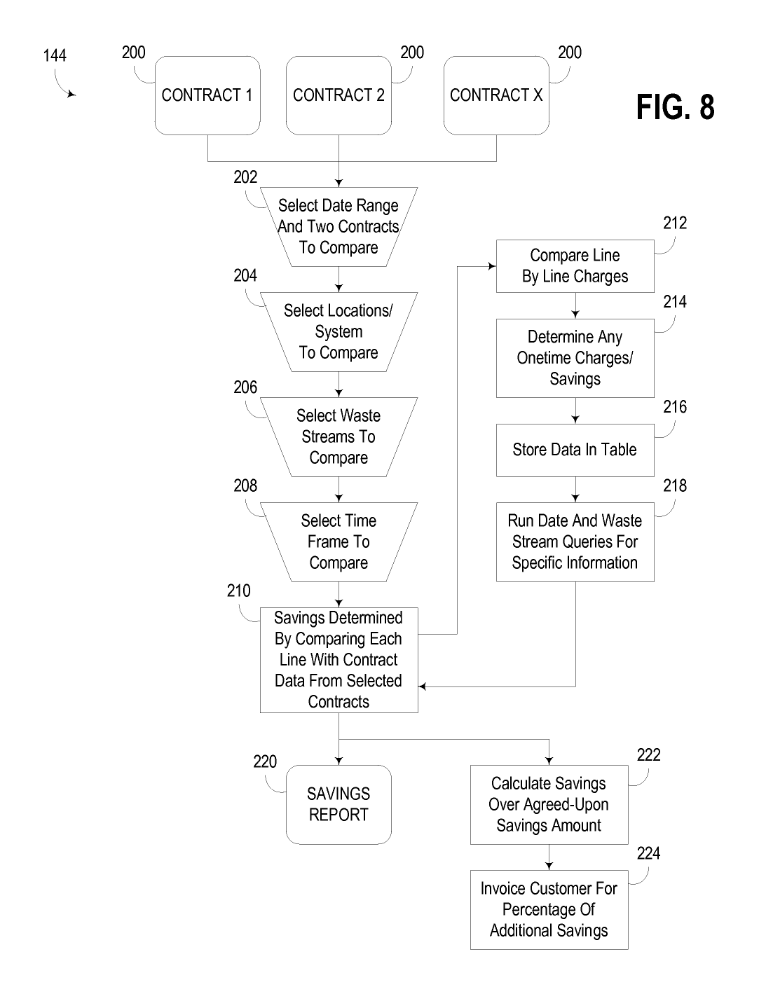

FIG. 8 next illustrates one implementation of the savings calculation process 144. Process 144 is capable of selecting any two contracts 200 (which may be service provider contracts, contracts entered into before and after performing an assessment of the customer's waste disposal services, and/or prospective contracts not yet entered into (e.g., to perform what-if analysis, or to show a potential customer the expected savings that might be obtained after modification of a customer's contract with a service provider. Process 144 begins in block 202 by receiving from an operator a selection of a date range and two contracts to compare. Next, the operator inputs specific locations, or selects the entire system, to compare in block 204. Block 206 also receives input as to which waste streams to compare, and block 208 receives a time frame to compare, with the time frame being past, present or future, with past, present or future pricing applied as appropriate, thus enabling, for example, contracts valid at other times to be run with current data, although in some embodiments, the comparison may not be limited to streams or time frames. Other parameters, e.g., organization, location, and summary/detail selection, may also be specified.

Next, in block 210, the savings between two contracts, also referred to as the realized cost reduction, are determined by comparing each line item for a location with contract data from the selected contracts. As shown in blocks 212-218, for example, block 210 may be implemented by first comparing the line by line charges in each contract in block 212, and determining any one time charges or savings in block 214 (e.g., reduced equipment charges). Other savings may be based upon process changes that are not directly reflected in service provider cost, e.g., improvements in customer efficiency, improvements in labor costs, improvements in fuel costs, improvements in taxes/government fees, etc.

Next, in block 216 the data is stored in a table, and in block 218, an operator may be permitted to run date and/or waste stream queries for specific information in the table. At this point, the results of the queries may also be formatted for inclusion in a report, or the format of a savings report 220, output by process 144, may otherwise be configured by the operator. The savings report reports the relative savings that were or could be achieved between two contracts.

While other formats are contemplated, Table I below, for example, provides an example summary report that might be presented to a customer:

TABLE I
Example Savings Report

| | | | | ACME | | |
|---|---|---|---|---|---|---|
| | | | | All | Start | Oct. 1, 2007 |
| | | | Organization | ACME | End | Oct. 31, 2007 |
| | | | Waste Stream | CWB | Contract 2 | ACME Pre- |
| Waste | Service | | Contract 1 | ACME | ACME Pre- | CWB |
| Stream | Date | Qty | Weight | CWB $ | CWB $ | Savings |
| MSW | October 2007 | 100 | 41,355.00 | $27,844.37 | $39,621.33 | $11,776.96 |
| RMW | October 2007 | 1955 | 83,024.00 | $225,652.77 | $275,921.53 | $50,268.76 |
| CDO | October 2007 | 1242 | 89,928.00 | $150,124.75 | $169,858.96 | $19,734.21 |

| | | | |
|---|---|---|---|
| Service Improvement | −$12,432.00 | | |
| Change in Frequency | −$8,594.00 | | |
| Labor Savings | −$10,422.44 | | |
| Total | $372,173.45 | $485,401.82 | $113,228.37 |

| | |
|---|---|
| Contracted Cost Reduction | $100,000.00 |
| Overage | $13,228.37 |
| Amount due CWB System (at 50/50 split) | $6,614.19 |

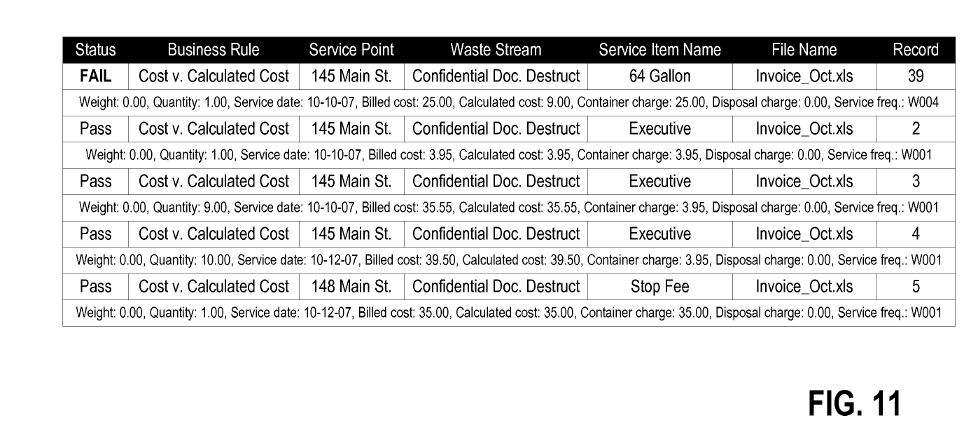

As also illustrated in FIG. 8, upon determining the savings, block 222 may also be executed to calculate a savings over an agreed-upon savings amount. As will be discussed in greater detail below in connection with FIG. 11, it may be desirable in some embodiments for the party performing the assessment and/or invoice validation to agree with the customer on a certain expected or promised cost reduction, and then, to the extent that the realized cost reduction exceeds that amount, the party and the customer may agree to split the additional savings according to some agreed upon amount, e.g., a fixed amount or percentage. While the implementation of such a split can originate from the customer or the third party, or from a completely separate party (e.g., a financial institution), in the embodiment shown in FIG. 8, the party simply bills the customer for the agreed upon amount (block 224), e.g., by including the charge as a line item on a composite invoice generated for the customer.

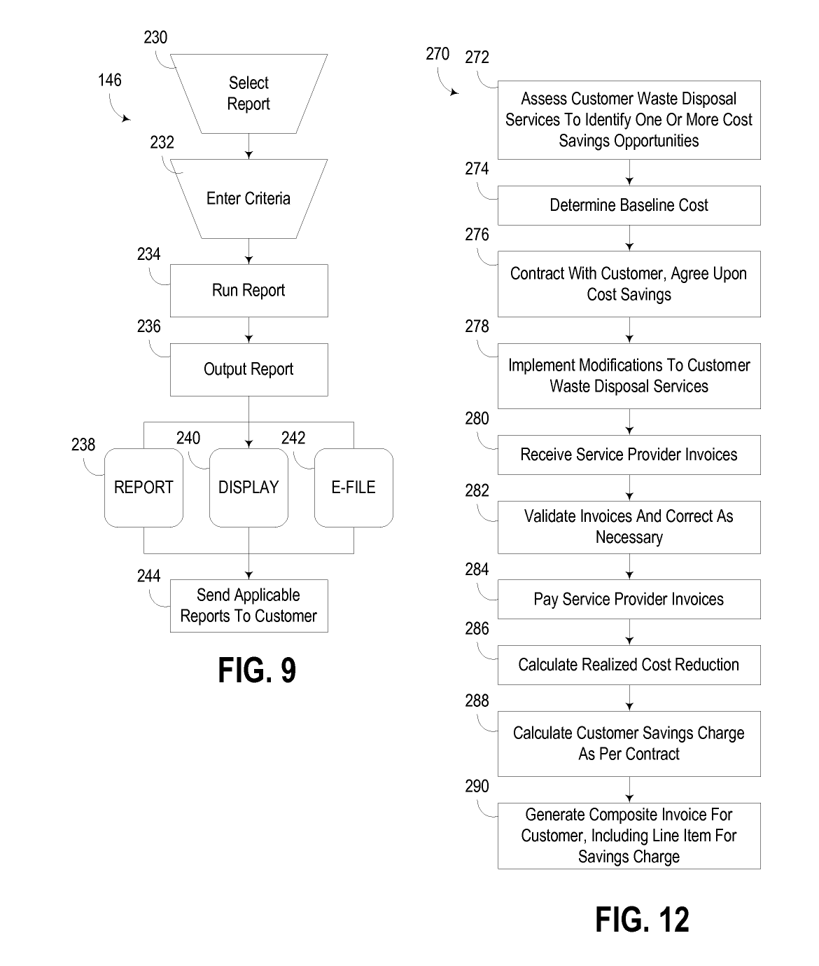

FIG. 9 next illustrates one implementation of reporting process 146 in greater detail. Reporting process 146 begins in block 230 by receiving user selection of a report, and then receiving user selected criteria in block 232. Different reports may be supported, e.g., system invoice errors, billings by customer, billings by waste stream, charges by invoice, charges by waste stream, customer summary, detail of internal billing codes, detail by customer, event logs, organization value lookups, regulated medical waste detail or summary, service point summary, service provider value lookup, customer hierarchy, waste stream business summary, waste stream summary by location, and other customer-focused, service provider-focused, waste stream-focused, etc., reports, and it will be appreciated that the types of user-configurable options that may be selected will vary from report to report, e.g., date ranges, selected locations and/or sub-locations, invoice ranges, selected organizations and/or sub-organizations, selected waste streams, input files, selected service locations or service points, etc.

Next, the selected report is run in block 234, and output in block 236. Various types of report output formats may be supported, including, for example, a paper report 238, display on a user screen 240, or an electronic report 242. Once generated, the applicable report may be sent to the customer in the appropriate manner for the report output format, as shown in block 244.

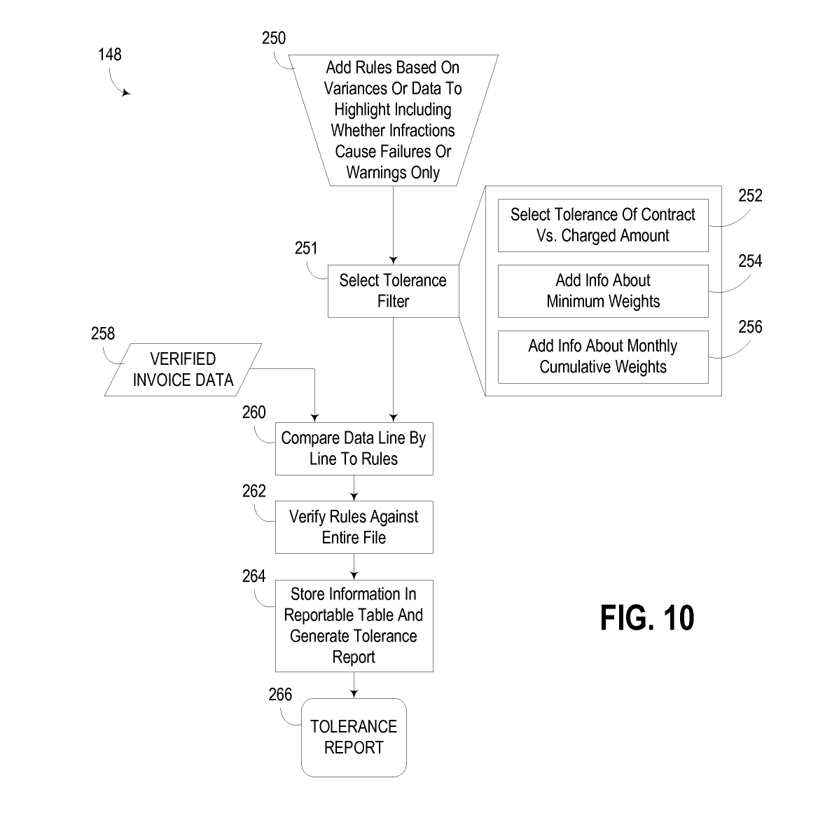

FIG. 10 next illustrates one implementation of tolerance calculation process 148. Process 148 is used to generate a tolerance report that highlights areas where invoices and charges by one or more service providers falls outside of tolerances established for the customer. Process 148 begins in block 250 by adding, in response to operator input, one or more rules based upon variances or data to be highlighted. Within these rules, actions may be specified such as whether an infraction causes a failure, and thus a rejection of an invoice, or whether the infraction only causes a warning to be issued, either via an alert or an entry in a log. It will be appreciated that more serious infractions will generally require a failure, while less serious infractions may simply be logged for later analysis. Other suitable actions for infractions will be appreciated by one of ordinary skill in the art having the benefit of the instant disclosure.

For example, one suitable rule might be “if billed cost is greater than or less than the calculated cost by more than $0.05, issue warning.” Another suitable rule might be, “if weight of container is less than a minimum desired weight, issue warning.”

Next, as shown in block 251, the operator selects a tolerance filter. Blocks 252-256, for example, illustrate several exemplary tolerance filters that may be selected. In block 252, for example, the operator may select a tolerance value for the contract, representing the amount of deviation that is allowed for the charged amount. As shown in block 254, the operator may add information about the minimum weights for the containers at particular service locations, e.g., to identify when containers are underutilized. In block 256, an operator may enter information about monthly cumulative weights for the service provider, to identify when a deviation occurs from a customer's typical usage.

Once the tolerance information is entered, the information, rules and the verified invoice data from the invoice validation process 9 (represented in block 258) is passed to block 260 to compare the invoice data line by line with the established tolerance rules. Rules are then verified against the entire invoice file in block 262, for those rules that are not specified to particular invoice items (e.g., overall costs, cumulative weights, etc.) The resulting information is then stored in a reportable table in block 264 and a tolerance report 266 is generated thereby.

FIG. 11, for example, illustrates a portion of one exemplary tolerance report that might be generated by process 148. In this report, the first entry illustrates a discrepancy, along with supporting details regarding why the discrepancy was highlighted. The remainder of the report illustrates entries for which no discrepancies were found.

Next turning to FIG. 12, an assessment and validation process incorporating cost reduction sharing consistent with the invention is illustrated at 270. As noted above, it may be desirable in some embodiments to motivate both the customer and a third party assessor and/or comprehensive billing service provider to reduce a customer's waste disposal costs by agreeing to split the cost reductions or savings resulting from the third party's efforts. For example, a customer and third party may agree upon a baseline cost reduction that is expected, or that the third party agrees to achieve (which may occur before or after an assessment is made). The customer and third party may also agree that, to the extent the cost reduction exceeds the agreed upon amount, a portion of that excess will go to the third party, e.g., a fixed amount, a percentage, a sliding scale, different amounts or percentages for different reduction levels, etc. This agreement may also be memorialized in the contract between the customer and third party. The calculation of savings, and the distribution to the third party, may also occur at different points in time, e.g., monthly, quarterly, yearly, and the time period over which savings must be realized may similarly vary (e.g., promised $X in savings per year).

As shown in FIG. 12, in one exemplary process, a customer assessment is performed, e.g., in the manner described above and in the aforementioned related applications, and as a component of this assessment, one or more cost savings opportunities are identified, e.g., by identifying underutilized service locations for which services could be reduced, such as containers that are too large for the amount of waste or pickup schedules that are too frequent for the amount of waste, or identifying areas in which service locations could be added or removed. Also, as shown in block 274, a baseline cost for the customer may be calculated, representing the customer's costs prior to modifying their waste disposal services. Next, in block 276, a contract is entered into with a customer, as a component of the contract, an agreed upon cost savings, or cost reduction, is specified, as is an agreement as to how excessive savings are distributed (e.g., a percentage of all excessive savings will be billed to the customer in their composite invoice). Once the contract is entered into, suggested modifications resulting from the assessment are implemented, e.g., by changing pickup schedules, adding or removing service locations, changing container sizes at certain service locations, contracting with new service providers, and routing customer invoices to the billing system instead of the customer.

Once the modifications are in place, post-contract service provider invoices are received by the CWB system in block 280, and as shown in block 282, the invoices are validated and corrected as necessary, in the manner described above. As a result, another potential savings opportunity that may factor into the savings calculation results from identifying a discrepancy between an actual cost and a contracted cost, and correcting the invoice so that only the contracted cost is paid to the service provider. Next, in block 284, the service provider invoices are paid, also in the manner described above.

Next, in block 286, typically at some time period, a realized cost reduction is calculated, representing the actual costs incurred by the customer compared to the baseline cost established above. Then, based upon this realized cost reduction, a customer savings charge is calculated in block 288, e.g., as a percentage of the amount the realized cost reduction exceeds the agreed upon cost reduction. Then, in block 290, the composite invoice is generated for the customer by aggregating the charges from multiple service providers, and the savings charge is included as a line item in the invoice. In addition, it will also typically be desirable to include in the invoice the data regarding the realized cost reduction and/or the calculation of the savings charge, so that the customer can see the savings that were realized compared to the baseline cost.

In an exemplary embodiment of the invention, for example, every month each service provider could send the CWB system a hard copy invoice as well as an e-file with the detailed charges capable of being processed by the CWB system. The e-file may contain all of the invoice information for every location, waste stream and service container that the service provider services for the customer. The file would be processed by the CWB System and initially validated for proper format. If columns were not in the correct format, information was missing, etc., a flag may be thrown to correct any formatting areas in the file. Once errors in format were corrected, the file would be reprocessed and individual lines would be validated. Information such as: account number exists, service container abbreviation exists, account number is tied a specific location for the customer, service container and waste stream provided are valid at customer service point, etc., would be validated. Once all individual line items were valid and approved, the file would be accepted by the system and processed.

Then, once the service provider format and invoice was verified, the costs provided by the service provider would be compared against the contractual amounts added during contract setup on a line by line basis. Each line item would be verified against the appropriate contract terms based on the rate set that is tied to the location and any applicable rates/calculations. The system could either flag any issues as warnings or fail the entire file. If the cost of a 30 yd Open Top was supposed to be $25/ton to dispose along with $130 to haul it away, the cost should be $180 for two tons of refuse to be handled. If the e-file did not show $180, the entire file could be rejected or that specific line could be highlighted for review but not cause the file to fail. A tolerance level may be added during contract setup that is utilized to determine if an e-file line should be highlighted or if it is valid, which is typically done so that rounding errors or other such issues are not marked as a problem. Once all e-file lines were validated against the contract, savings could be determined and special reports could be run.

In addition, once all charges were entered and accepted by the CWB system for a customer, management reports could be run and provided to individuals both within the customer and the CWB system. Files may be created that electronically update the charges with specific general ledger codes detailing who should be charged what.

Savings may be determined by comparing one contract vs. another. A customer's contract information may be validated and added into the CWB system as well as current contractual amounts. Once the e-file is validated it could be used to compare the cost between one contract, service provider or customer vs. another. If the costs are less it is a savings. The savings comparisons could be reported line by line or summarized based on waste streams, locations and time frames.

In addition, special reports or tolerances may be considered as special conditions that are treated similar to rates/rate sets. Calculations can be created or simple line by line comparisons can be shown that will flag any occurrences outside a tolerance predetermined and entered into the system. An example would be all 95 gallon containers for Medical Waste that weigh less than 150 lbs.

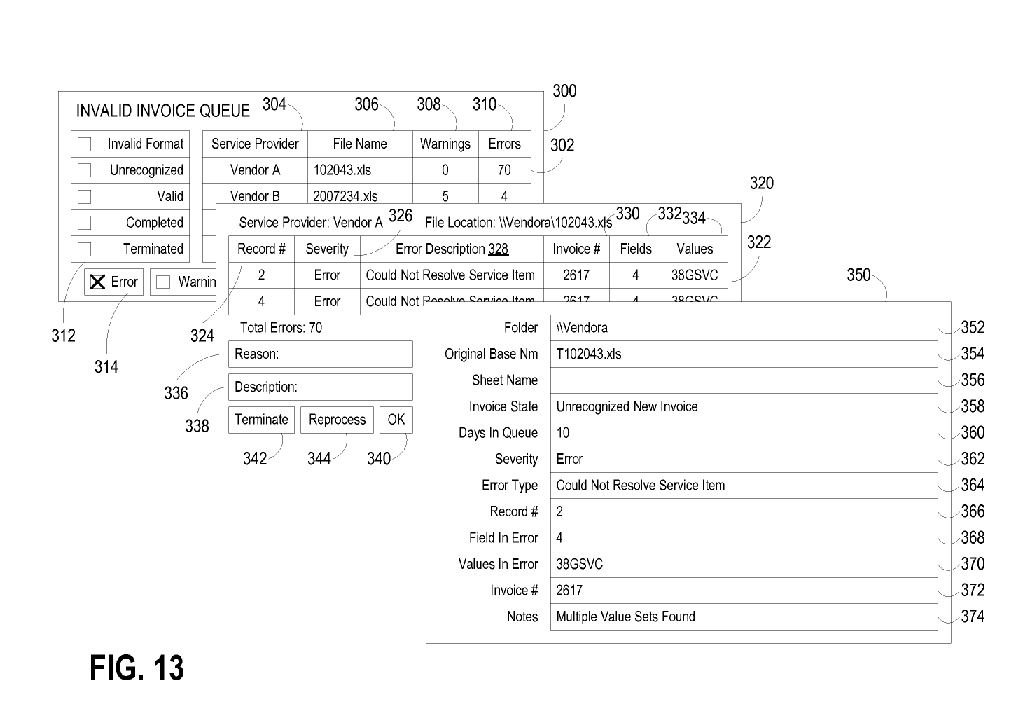

Now turning to FIG. 13, an exemplary display of invoice discrepancies, as might be generated subsequent to invoice and/or contract validation, is illustrated. In particular, FIG. 13 illustrates an invalid invoice queue window 300 that displays a list of entries 302 corresponding to invalid invoices detected during invoice validation. Each entry 302 identifies a service provider 304, file name 306, warning count 308 and error count 310. In this implementation, a warning is a discrepancy that is merely highlighted, while an error is a discrepancy that precludes further processing of the invoice. Window 300 includes various filters 312, e.g., to filter based on entry status (invalid format, unrecognized, valid, completed, terminated), as well as to filter to include errors and/or warnings only (checkboxes 314).

FIG. 13 illustrates the selection of entry 302, which brings up another window 320 providing detail on the errors associated with a particular invoice or e-file. Window 320 identifies the service provider and location of the e-file, and includes a plurality of entries 322, each identifying a record number 324, severity level 326 (warning or error), error description 328, invoice number 330, field(s) in error 332, and value(s) in error 334. For each entry, an operator is permitted to enter a reason code 336 and/or description 338. Furthermore, buttons are provided to close the window (340), terminate the processing of the file (342) or reprocess the file (344).

FIG. 13 also illustrates the selection of entry 322, which brings up another window 350 providing detail on a single discrepancy. Fields are provided for folder/file location 352, original base (file) name 354, sheet name 356, invoice state 358, days in queue 360, severity 362, error type 364, record number 366, fields in error 368, values in error 370, invoice number 372 and notes 374.

While FIG. 13 illustrates specific errors and error and display formats, it will be appreciated that a multitude of other errors and formats may be presented to an operator consistent with the invention. In addition, various other modifications to the illustrated embodiments will be apparent to one of ordinary skill in the art. Therefore, the invention lies in the claims hereinafter appended.

What is claimed is:

1. A method of processing a service provider invoice associated with delivery of waste disposal service, the method comprising:
receiving invoice data associated with a service provider invoice, the invoice data identifying at least one waste disposal service provided at a service location for a customer and a cost for the waste disposal service;
accessing service location data for the customer to validate the waste disposal service provided by the service provider at the service location; and
accessing contract data associated with a contract between the service provider and the customer to validate the cost for the waste disposal service.

2. The method of claim 1, wherein accessing the service location data to validate the waste disposal service comprises using a mapping matrix to compare a service location identifier from the invoice data with a service location identifier from the service location data.

3. The method of claim 2, wherein the mapping matrix is configured to map a service location identifier for the service provider with a service location identifier for the customer.

4. The method of claim 1, wherein accessing the service location data to validate the waste disposal service comprises determining whether a service location identified in the invoice data exists.

5. The method of claim 1, wherein accessing the service location data to validate the waste disposal service comprises determining whether a waste stream identified in the invoice data is present at the service location.

6. The method of claim 1, wherein accessing the service location data to validate the waste disposal service comprises determining whether the service provider is authorized to perform the waste disposal service at the service location.

7. The method of claim 1, wherein accessing the service location data to validate the waste disposal service comprises determining whether a service item identified in the invoice data is present at the service location.

8. The method of claim 1, further comprising validating a format of the invoice data for compatibility with a comprehensive waste billing system.

9. The method of claim 1, wherein accessing the contract data to validate the cost for the waste disposal service comprises accessing rate data associated with the service location and determining whether the cost is accurate based upon the rate data.

10. The method of claim 1, wherein accessing the contract data to validate the cost for the waste disposal service comprises accessing rate data associated with the service location and determining whether the cost is within a tolerance based upon the rate data.

11. The method of claim 1, further comprising, with a third party, validating invoice data for a plurality of service provider invoices from a plurality of service providers and generating a composite invoice for the customer.

12. The method of claim 11, further comprising using a mapping matrix to supply a customer charge code for a plurality of line items in the composite invoice.

13. The method of claim 11, further comprising, with a third party, paying the plurality of service provider invoices on behalf of the customer.

14. The method of claim 11, further comprising:
comparing a total cost associated with plurality of invoices and a baseline cost to determine a realized cost reduction; and
determining an amount due from the customer to the third party resulting from the realized cost reduction exceeding an agreed-upon cost reduction promised to the customer by the third party.

15. The method of claim 1, wherein the contract is a first contract, the method further comprising:
accessing contract data associated with a second contract to generate a cost for the waste disposal service according to the second contract; and
generating a report comparing the respective costs for the waste disposal service according to the first and second contracts.

16. An apparatus, comprising:
a processor; and
program code configured to be executed by the processor to process a service provider invoice associated with delivery of waste disposal service by receiving invoice data associated with a service provider invoice, the invoice data identifying at least one waste disposal service provided at a service location for a customer and a cost for the waste disposal service; accessing service location data for the customer to validate the waste disposal service provided by the service provider at the service location; and accessing contract data associated with a contract between the service provider and the customer to validate the cost for the waste disposal service.

17. The apparatus of claim 16, wherein the program code is configured to access the service location data to validate the waste disposal service by using a mapping matrix to compare a service location identifier from the invoice data with a service location identifier from the service location data, wherein the mapping matrix is configured to map a service location identifier for the service provider with a service location identifier for the customer.

18. The apparatus of claim 16, wherein the program code is configured to access the service location data to validate the waste disposal service by performing at least one of: determining whether a service location identified in the invoice data exists, determining whether a waste stream identified in the invoice data is present at the service location, determining whether the service provider is authorized to perform the waste disposal service at the service location, and determining whether a service item identified in the invoice data is present at the service location.

19. The apparatus of claim 16, wherein the program code is configured to access the contract data to validate the cost for the waste disposal service by accessing rate data associated with the service location and determining whether the cost is accurate based upon the rate data.

20. The apparatus of claim 16, wherein the program code is configured to, with a third party, validate invoice data for a plurality of service provider invoices from a plurality of service providers, pay the plurality of service provider invoices on behalf of the customer, and generate a composite invoice for the customer.

21. The apparatus of claim 20, wherein the program code is configured to compare a total cost associated with plurality of invoices against a baseline cost to determine a realized cost reduction, and determine an amount due from the customer to the third party resulting from the realized cost reduction exceeding an agreed-upon cost reduction promised to the customer by the third party.

22. The apparatus of claim 16, wherein the contract is a first contract, and wherein the program code is further configured to access contract data associated with a second contract to generate a cost for the waste disposal service according to the second contract, and generate a report comparing the respective costs for the waste disposal service according to the first and second contracts.

23. A program product, comprising:
a computer readable medium; and
program code resident on the computer readable medium and configured to process a service provider invoice associated with delivery of waste disposal service by receiving invoice data associated with a service provider invoice, the invoice data identifying at least one waste disposal service provided at a service location for a customer and a cost for the waste disposal service; accessing service location data for the customer to validate the waste disposal service provided by the service provider at the service location; and accessing contract data associated with a contract between the service provider and the customer to validate the cost for the waste disposal service.

24. A method of billing a customer for waste disposal services provided by a plurality of waste service providers, the method comprising:
determining a baseline cost associated with the provision of waste disposal services for the customer by the plurality of waste service providers;
with a third party, assessing the provision of waste disposal services for the customer to identify at least one cost saving opportunity for the customer;
determining a realized cost reduction resulting from implementation of the cost saving opportunity; and
determining an amount due from the customer to the third party resulting from the realized cost reduction exceeding an agreed-upon cost reduction promised to the customer by the third party.

25. The method of claim 24, wherein assessing the provision of waste disposal services comprises:
receiving a plurality of invoices for the customer from the plurality of service providers;
validating the plurality of invoices;
aggregating charges from the plurality of invoices into a composite invoice; and
forwarding the composite invoice to the customer.

26. The method of claim 25, wherein assessing the provision of waste disposal services further comprises identifying a discrepancy in an invoice between an actual cost and a contracted cost, wherein determining the realized cost reduction comprises determining a difference between the actual cost and the contracted cost.

27. The method of claim 25, wherein assessing the provision of waste disposal services further comprises identifying an underutilized service location for the customer, wherein determining the realized cost reduction comprises determining a difference between costs for servicing the service location before and after a reduction in service to the underutilized service location.

28. The method of claim 27, wherein the reduction in service comprises at least one of replacing a container at the service location with a smaller container and reducing a frequency of pickup for the service location.

29. The method of claim 25, wherein the plurality of invoices comprise a plurality of post-contract invoices received after the customer has contracted with the third party to assess the provision of waste disposal services for the customer, wherein determining the baseline cost comprises assessing a second plurality of invoices received by the customer prior to contracting with the third party.

30. The method of claim 25, wherein determining the amount due from the customer includes adding a line item to the composite invoice for an agreed-upon percentage of the difference between the realized cost reduction and the agreed-upon cost reduction.

31. The method of claim 24, wherein determining the baseline cost includes determining a cost prior to the customer contracting with the third party to assess the provision of waste disposal services for the customer, wherein the agreed-upon cost reduction includes a contracted cost reduction, and wherein determining the amount due from the customer comprises charging the customer for an agreed-upon percentage of the difference between the realized cost reduction and the agreed-upon cost reduction.
